(19) United States
(12) Patent Application Publication
(10) Pub. No.: US 2008/0002140 A1
(43) Pub. Date: Jan. 3, 2008

(54) Method and apparatus for manufacturing a Liquid Crystal Display panel

(75) Inventor: Toshihiko Motomatsu, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD TECHNOLOGIES, LTD., Kawasaki (JP)

(21) Appl. No.: 11/819,960

(22) Filed: Jun. 29, 2007

(30) Foreign Application Priority Data
Jul. 3, 2006 (JP) 182947/2006

(51) Int. Cl. G02F 1/13

(52) U.S. Cl. 349/187

(57) ABSTRACT

A method for manufacturing a Liquid Crystal Display (LCD) panel has irradiating a position on a substrate used for the LCD panel with ultraviolet rays and performing a process to the position before predetermined time elapses. An LCD panel manufacturing apparatus for manufacturing an LCD panel of the present invention has a process unit including a ultraviolet cleaning unit which irradiates a predetermined position on a substrate with ultraviolet rays and a processing head which performs a predetermined process to the predetermined position on the substrate, the processing head being located at a predetermined distance from the ultraviolet cleaning unit, and a mobile unit which moves at least one of the process unit and the substrate so as to shift the processing head to the predetermined position before a predetermined time elapses.

### BACKGROUND OF THE INVENTION

1. Field of the Invention

The present invention relates to a method and apparatus for manufacturing a Liquid Crystal Display (LCD) panel and in particular, relates to a method and apparatus for manufacturing an LCD panel which is used in a step after a rubbing washing and a drying in a process of manufacturing an LCD panel.

2. Description of the Related Art

Since an LCD has advantages such as a slim outline, light weight and low power consumption, it is widely used for Audio Visual (AV) equipment and Office Automation (OA) equipment. An LCD includes an LCD panel which consists mainly of two substrates and liquid crystal filled into a gap therebetween. One of two substrate (hereinafter, referred to as “TFT substrate”) is a substrate on which switching elements such as Thin Film Transistors (TFTs) are formed in a matrix shape. The other substrate (hereinafter, referred to as “CF substrate”) is a substrate on which a color filter (CF) and a black matrix (BM) or the like are formed. In an LCD panel, a light transmittance is changed by controlling an orientation of liquid crystal molecules using an electric field generated between electrodes that are provided on one or both substrates.

FIG. 10 is a sequence diagram showing steps included in processes for manufacturing a TFT substrate and a CF substrate used for an LCD panel. First, the TFT substrate and the CF substrate are washed and dried. Next, an orientation film is formed on surfaces facing each other of both substrates. Next, in order to control an orientation of liquid crystal molecules, a rubbing process is performed to the orientation film. Next, in order to remove fibers of a rubbing cloth, shavings of the orientation film or the like, a rubbing washing and a drying are performed to the orientation film of the TFT substrate and the CF substrate. Next, a spacer spraying and a spacer adhering are performed to either one of the TFT substrate or the CF substrate. A sealant or a conducting member (the conducting member shown in FIG. 10 is a silver paste) is applied to the other substrate. After dropping a liquid crystal therebetween, two substrates are bonded together to form an LCD panel. A conventional process for manufacturing a TFT substrate and a CF substrate includes the steps mentioned above. A series of steps mentioned above, from a step of forming each substrate to a step of bonding two substrates together, is called as a panel assembling step.

The panel assembling step usually includes two steps for cleaning a substrate. One is a cleaning & drying step which is a first step of a panel assembling step and the other is a rubbing washing & drying step after performing a rubbing process. In the cleaning & drying step, a Ultraviolet (UV) cleaning is usually employed. The UV cleaning is a process in which UV rays irradiate organic matter to decompose and remove them.

A contact angle is used as an index of cleanliness of a substrate. The contact angle is an angle between a free surface of a liquid and a solid surface. The contact angle depends on the liquid used for the measurement of it. The contact angle can be measured with any suitable liquid. The contact angle in the present invention is measured using pure water. The method of measuring a contact angle is described later in the second exemplary embodiment. The contact angle is affected by storage environment of the substrate. The contact angle of a substrate before performing a board cleaning & drying process is normally 25 to 30 degrees for a TFT substrate and 35 to 40 degrees for a CF substrate. In contrast, contact angles of both substrates are less or equal to 10 degrees just after the board cleaning & drying process has been performed. The contact angle is decreased by UV cleaning. However, the contact angle gradually increases as time passes, because a substrate surface becomes contaminated.

FIG. 11 shows a relation between elapsed time after cleaning a substrate and a contact angle of the substrate. FIG. 11 shows that the contact angle of the substrate surface increases as much time elapses. The contact angle is 5 degrees just after cleaning a substrate. Usually, it takes about 5 hours from a substrate cleaning to a completion of a rubbing process. Accordingly, at a time when a rubbing process is completed, the contact angle increases by around 20 degrees. FIG. 11 indicates that the substrate surface has been contaminated. It is difficult to uniformly form a film on the contaminated surface of the substrate using members such as a sealant, a silver paste, a spacer or the like.

Various methods are proposed to solve such a problem with a contamination on a substrate surface. For example, Japanese Patent Application Laid-Open No. 2002-196337 discloses a method for reducing a contamination on a substrate surface by adding a step in which UV rays irradiate a substrate before a step of forming an insulation film or an orientation film. Japanese Patent Application Laid-Open No. 1998-68917 discloses a method for reducing contamination on a substrate surface by adding a step in which UV rays irradiate a substrate before a step of forming a sealant layer, an overcoat layer on a CF substrate or the like.

As mentioned above, by performing a cleaning & drying step, contamination on a substrate surface temporarily reduces. However, in a subsequent step, contamination on a substrate surface increases again due to time elapsing. Therefore, in later steps, worse contamination occurs. For this reason, if a substrate surface is contaminated at a time of a sealant applying step, it causes “seal flaw” as shown in FIG. 12a or “sealant cissing” as shown in FIG. 12b. “Seal flaw” means a state in which a coated sealant is flawed. “Sealant cissing” means a state in which a width of a sealant becomes larger or smaller when the sealant is repelled by a surface where a sealant should be applied. When the seal flaw or the sealant cissing occurs, a wetting failure 50 of liquid crystal occurs in an LCD panel as shown in FIG. 13.

The above-mentioned coating failure occurs in not only a step of applying a sealant but also a step of applying a conducting member such as a silver (Ag) paste. That is, a coating failure such as “Ag paste remaining” or “Ag paste cissing” occurs and as a result, a failure in electric continuity of an Ag wiring occurs. Further, “Ag paste remaining” is a coating failure in which an Ag paste to be applied remains in a nozzle of the material applicator when the Ag paste is not applied from the nozzle of the material applicator on a part to be coated of a substrate due to cissing on a surface of the part to be coated of a substrate. “Ag paste cissing” is a coating failure in which an applied Ag paste is repelled by a surface to be coated and a shape of the applied Ag paste becomes small and a doughnut (hollow) shape.

If a substrate is contaminated at a time of a spacer spraying step, the contamination may cause a failure in a spacer adhering. The failure in a spacer adhering is also called “spacer moving” and it is a failure in which because a spacer is not certainly fixed to a substrate, the spacer moves. As a result, a cell gap failure occurs in which a gap between two substrates of an LCD panel is smaller than a specified value or the gap is not uniform.

In manufacturing processes shown in Japanese Patent Application Laid-Open No. 2002-196337 and Japanese Patent Application Laid-Open No. 1998-68917, a UV cleaning step is set before a step of forming a member or a substance. However, steps from UV cleaning to forming a film on a substrate surface are not continuously performed. Therefore, a cleaning of a surface part of a substrate before forming a film is insufficient and as a result, for example, a film is nonuniformly formed or a coating failure occurs suddenly. In particular, when a trouble occurs in a production line and a process of a substrate stops, a number of failures occur.

Thus, since contamination on a substrate surface spreads as time elapses after performing a cleaning & drying step, an elapsed time period between performing a UV cleaning process and a next step in which a member is formed on the substrate surface becomes very important. However, in a conventional method, because an elapsed time period between film forming and a cleaning & drying step becomes long, a film is formed on a contaminated substrate surface. Accordingly, there are problems in which a film is not coated on and is not adhered to the substrate appropriately. Therefore, a method and an apparatus for manufacturing an LCD panel which can stably form members on a substrate by controlling an elapsing time period are desired.

### SUMMARY OF THE INVENTION

The present invention was made to solve the foregoing and other exemplary problems, drawbacks, and disadvantages. An exemplary feature of the present invention is to provide a method and an apparatus for manufacturing an LCD panel which can realize high quality and high yield rate by preventing an occurrence of a failure caused by a contamination on a surface on which materials are applied in an assembling step of an LCD panel.

A method for manufacturing a liquid crystal display panel of the present invention has irradiating a position on a substrate used for the liquid crystal display panel with ultraviolet rays and performing a process to the position before predetermined time elapses.

A liquid crystal display panel manufacturing apparatus for manufacturing a liquid crystal display panel of the present invention has a process unit including a ultraviolet cleaning unit which irradiates a predetermined position on a substrate with ultraviolet rays and a processing head which performs a predetermined process to the predetermined position on the substrate, the processing head being located at a predetermined distance from the ultraviolet cleaning unit, and a mobile unit which moves at least one of the process unit and the substrate so as to shift the processing head to the predetermined position before a predetermined time elapses.

In the present invention, there is an advantage that a spreadability of the material and adhesion strength of the material are improved and a coating failure can be prevented by carrying out UV cleaning just before applying the material in a material applying step of an LCD panel assembling step. Moreover, because width of a line to which the material is applied can be made small due to an improvement of adhesion strength, a large design margin can be obtained and material usage can be reduced.

An LCD panel can be manufactured with high quality and high yield rate by solving a problem of a failure in material applying in an LCD panel assembly line.

Other exemplary features and advantages of the present invention will be apparent from the following description taken in conjunction with the accompanying drawings, in which like reference characters designate the same or similar parts throughout the figures thereof.

### BRIEF DESCRIPTION OF THE DRAWINGS

Exemplary features and advantages of the present invention will become apparent from the following detailed description when taken with the accompanying drawings in which:

FIG. 1 is a sequence diagram showing each step included in a manufacturing process of an LCD panel of a first embodiment of the present invention;

FIG. 2 is a side view showing a coating work by a material applicator of a first embodiment of the present invention;

FIG. 3 is a top view showing a schematic configuration of a material applicator of a first embodiment of the present invention;

FIG. 4 is an external view of a spacer spraying apparatus of a first embodiment of the present invention;

FIG. 5a is an external view of a spacer adhering apparatus of a first embodiment of the present invention;

FIG. 5b is a top view showing a schematic configuration of another spacer adhering apparatus of a first embodiment of the present invention;

FIG. 6 is a plan view showing a measurement method of a contact angle;

FIG. 7 shows a relation between a contact angle and a time when a substrate is left under uncontrolled condition;

FIG. 8 shows a relation between an accumulated amount of UV light and NMP shrink completion time for each type of UV lamps used for UV cleaning;

FIG. 9 is a sequence diagram showing each step included in another manufacturing process of an LCD panel of the present invention;

FIG. 10 is a sequence diagram showing each step included in a conventional manufacturing process of an LCD panel;

FIG. 11 shows a relation between a time when a substrate is left unattended and a contact angle after cleaning a substrate;

FIG. 12a schematically shows an example of a seal flaw;

FIG. 12b schematically shows an example of a sealant cissing;

FIG. 13 schematically shows an example of an LCD panel in which a wetting failure of a liquid crystal occurs.

### DETAILED DESCRIPTION OF THE EXEMPLARY EMBODIMENTS

Exemplary embodiments of the present invention will now be described in detail in accordance with the accompanying drawings.

### 1. First Exemplary Embodiment

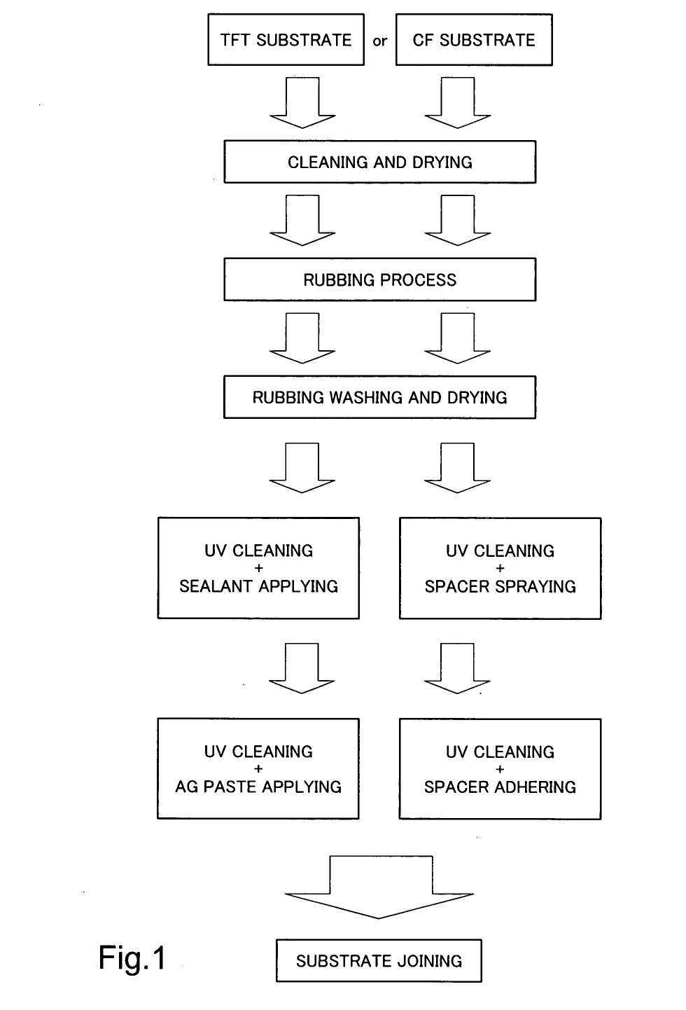

A method and an apparatus for manufacturing an LCD panel of the first exemplary embodiment of the present invention will be described with reference to FIG. 1 to 3. An LCD panel of an LCD mainly consists of two transparent substrates, a first substrate and a second substrate. Switching elements such as thin film transistors are formed in a matrix form on the first substrate. A color filter, a black matrix and the like are formed on the second substrate. Hereinafter, a TFT substrate is taken as an example of the first substrate and a CF substrate is taken as an example of the second substrate. On each surface of these two substrates that face each other, an orientation film is formed and an orientation process (i.e. rubbing process) is applied. By placing an electrical insulating spacer including particles such as polymer beads or silica beads in predetermined shapes between both substrates, a predetermined gap is formed. Orientation of a liquid crystal material sealed in the gap is controlled by using an electric field generated by an electrode that is formed on at least one substrate to display an image. In order to secure high quality and high yield rate with respect to the LCD panel, a process in each step has to be performed on the substrate surface having no contaminants. In this exemplary embodiment, the LCD panel is manufactured by a method described below.

Each step in a manufacturing process of an LCD panel according to the first exemplary embodiment of the present invention will be described with reference to FIG. 1. In an LCD panel manufacturing process, in order to clean surfaces of a TFT substrate and a CF substrate, cleaning and drying are performed in a cleaning & drying step that is a first step. Next, in an orientation film printing step (not shown), an orientation material is applied on a surface of a substrate to form an orientation film. Next, in order to control an orientation of liquid crystal molecules, in a rubbing process step, a rubbing process is performed to the orientation film. Next, in a rubbing washing & drying step, in order to remove fibers of a rubbing cloth, shavings of the orientation film or the like that are left in the rubbing process step, cleaning and drying are performed. In general, a panel manufacturing process follows the steps mentioned above.

In this exemplary embodiment, UV cleaning is performed in at least one step of a sealant applying step, an Ag paste applying step, a spacer spraying step and a spacer adhering step that are performed after the rubbing washing & drying step. That is, in each step, UV cleaning is performed just before performing a material applying process, a material spraying process, or a spacer adhering process etc. onto the CF substrate or the TFT substrate. Further, an Ag paste is a conducting material for connecting electrodes provided in the TFT substrate and the CF substrate. After that, an LCD panel is assembled by dropping a liquid crystal material between the TFT substrate and the CF substrate and then joining two substrates together, or by joining two substrates together and then injecting a liquid crystal material into a gap between the TFT substrate and the CF substrate.

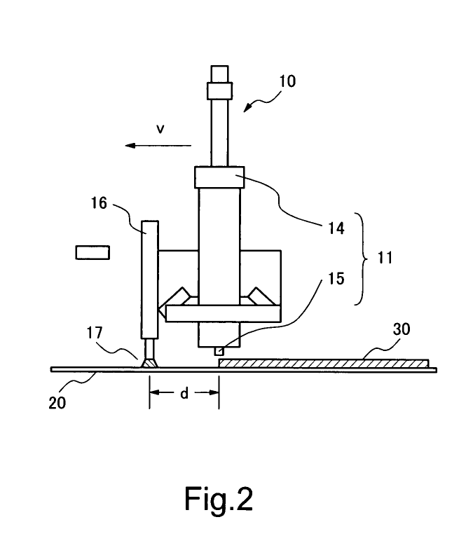

For example, UV cleaning is performed to a surface of the CF substrate or the TFT substrate just before applying a sealant in a sealant applying step, or just before applying an Ag paste in an Ag paste applying step. For performing the UV cleaning, for example, a manufacturing apparatus having a UV cleaning unit that is provided on an “upstream side” of a coating unit for applying a material is used. Here, the “upstream side” is a direction in which a coating unit moves for applying a material on a substrate and it is a left side in FIG. 2 (described later). Further, it may be possible to move a substrate instead of moving a coating unit. In this case, the “upstream side” is a direction opposite to the direction in which the substrate moves.

Just after the UV cleaning, following the UV cleaning, a material is applied by a coating unit that is provided on a “downstream side” of the UV cleaning unit. In other words, the UV cleaning process is performed on an upstream and at the same time, a material applying process is performed on a downstream side. Thereby, the UV cleaning process and the material applying process can be continuously performed in this order. Thus, by continuously performing the UV cleaning and the material applying of a sealant, an Ag paste etc., the sealant or the Ag paste can be applied on a highly clean substrate surface. Therefore, a coating failure (i.e. “seal flaw” or “sealant cissing” with respect to a sealant, “Ag paste remaining” or “Ag paste cissing” with respect to an Ag paste) can be reduced.

As a further effective method, the UV cleaning may be performed to an only area where the sealant or the Ag paste is applied and neighboring area thereof. Specifically, as shown in FIG. 2, a pinpoint UV light is applied by using a material unit 10. The material unit 10 includes a coating head 11 having a cylinder 14, a nozzle 15 etc. and a UV lamp 16. A pinpoint UV light is applied to the area where the sealant or the Ag paste is applied by using the UV lamp 16 just before applying them by the material unit 10. FIG. 2 shows a sealant 30 as an example of a material to be applied.

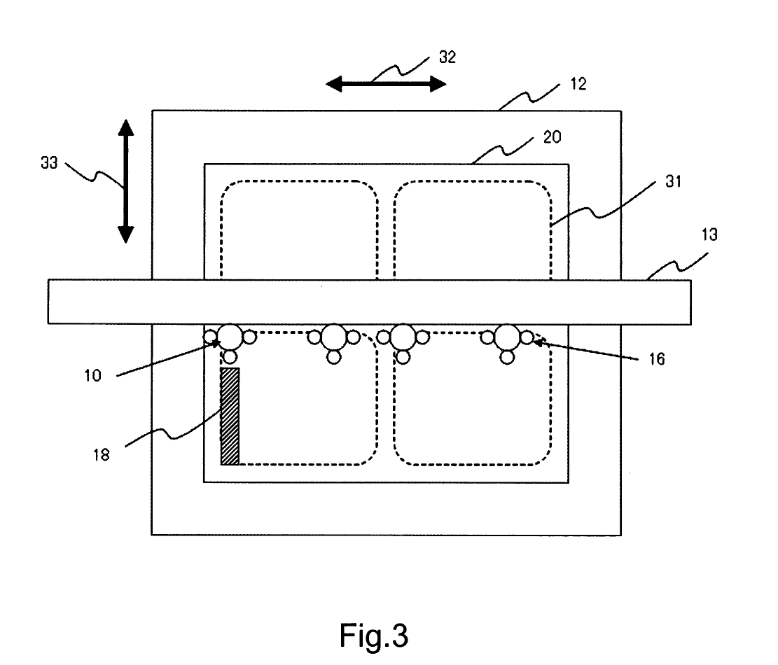

FIG. 3 shows an example of a material applicator mounted with a coating head with built-in UV lamp for applying a sealant or an Ag paste. The material applicator includes a coating unit 10, a stage 12, a rail 13 for a movable coating unit, the UV lamp 16 and a mobile unit 18. Four coating units 10 are provided. All the coating units 10 are fixed to the rail 13 for a movable coating unit which is placed over the stage 12. The stage 12 can be two-dimensionally moved in a direction indicated by arrows 32 and 33. A transparent insulating substrate (hereinafter, referred to as a glass substrate 20) made of glass, plastic etc. is fixed on the stage 12. The UV lamp 16 is placed at a location in a moving direction of each coating unit 10 (FIG. 3 shows three lamps). The UV lamp 16 irradiates the glass substrate 20 by UV rays 17. Further, it may be possible that the glass substrate 20 is fixed and the coating unit 10 moves on the rail 13 for a movable coating unit instead of moving the glass substrate 20.

The material applicator can perform UV cleaning to an only area which is adjacent to a position to be coated just before applying a sealant or a Ag paste (in this case, the sealant 30) to the glass substrate 20. In FIG. 3, UV rays are irradiated an area 18 of the glass substrate 20 by moving a stage in a direction indicated by an arrow 34. An area 31 surrounded by a broken line is a whole area to which the sealant 30 is applied. By repeated UV radiation to the area 18 and moving the stage 12, the UV rays radiation and coating of the sealant 30 can be performed to the whole of the area 31. The material applicator can control a UV cleaning level based on parameters such as an accumulated amount of UV light and a moving speed condition of a substrate. By using such material applicator, a sealant or an Ag paste can be applied efficiently on a clean substrate. Therefore, spreadability is further improved.

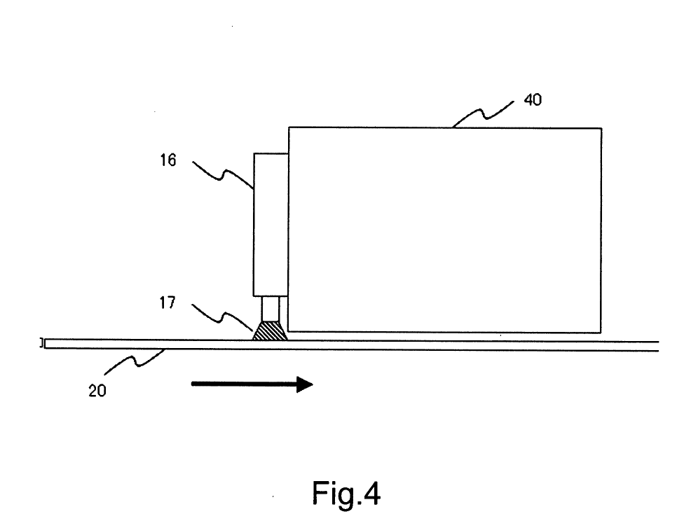

In a spacer spraying step, UV cleaning is performed to a surface of the CF substrate or the TFT substrate just before spraying a spacer. In order to spray a spacer, in the spacer spraying step, a spacer sprayer having a spraying unit in a chamber is used. FIG. 4 shows an external view of the spacer sprayer. The spacer sprayer 40 comprises a chamber 40 and the UV lamp 16. The UV lamp 16 is fixed at an entrance of the chamber 40 to which a substrate is conveyed. The UV lamp 16 irradiates the glass substrate 20 by the UV rays 17. A nozzle (not shown) for spraying a spacer is provided in the chamber 40.

Further, the UV lamp 16 may be provided in the chamber 40. In this case, the UV lamp 16 is installed at a position that is closer to the entrance than that of a nozzle for spraying a spacer.

By using a spacer sprayer shown in FIG. 4, in a spacer spraying step, a spacer is sprayed on a highly clean substrate. Therefore, a substrate surface layer (i.e. an orientation film layer) and a spacer surface layer are fixed each other in a chemically stable state. Accordingly, a spacer adhering failure (i.e. movement of a spacer) caused by contamination of a substrate surface can be prevented.

In a spacer adhering step, just before adhering a spacer, UV cleaning is performed to a surface of the CF substrate or the TFT substrate. For example, a UV cleaning process and a spacer adhering process are performed continuously by using a manufacturing apparatus having a UV cleaning unit at an upstream side (i.e. a direction in which a adhering apparatus is moved or a direction opposite to a direction in which a substrate is moved) of a adhering apparatus for performing a spacer adhering process.

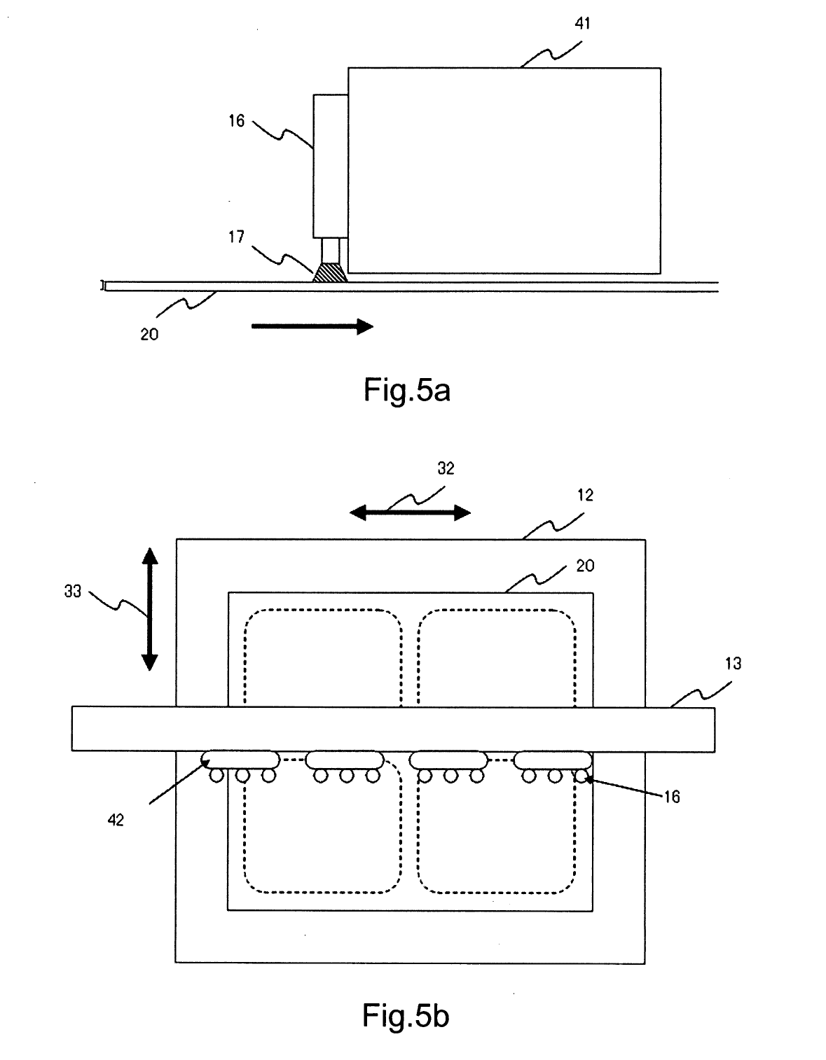

FIG. 5a shows an example of a spacer adhering apparatus. A spacer adhering apparatus is mainly structured by an oven 41 and the UV lamp 16. The UV lamp 16 is fixed at an entrance of the oven 41 to which a substrate is conveyed. The UV lamp 16 irradiates the glass substrate 20 using the UV rays 17. The oven 41 is a hot air circulation oven which includes components such as a heater, a fan or the like (not shown) for generating a hot air therein. Further, a heating method is not limited to a method using a hot air. For example, a method using an infrared ray may also be possible.

FIG. 5b shows an example of a spacer adhering apparatus having a spacer adhering unit with built-in UV lamp. A basic configuration is the same as the material applicator shown in FIG. 3. However, an adhering unit 42 is used instead of the coating unit 10. The adhering unit 42 adheres a spacer by widely and uniformly heating a whole area of the substrate 20 on which a spacer is sprayed. Further, in particular, any heating method may be possible. For example, a method using an infrared ray or a method using a hot air may be possible.

By using the above mentioned spacer adhering apparatus, in the spacer adhering step, a heat treatment is performed to a substrate having a highly clean substrate surface. Therefore, an abnormal orientation caused by a contaminant that is suddenly generated around a spacer can be reduced.

Since cleanliness of the substrate surface reduces as time elapses, it is desirable to shorten an elapsing time period until the material applying process or the spacer adhering starts after the UV cleaning. An elapsing time period t (min) is defined as follows:

t=d/v

where, d (mm) is a distance between a UV cleaning unit and a coating unit or an adhering unit, v (mm/min) is a moving speed of a substrate (refer to FIG. 2). It has been confirmed that advantageous results are contained under the condition of the elapsing time period t less than or equal to around 15 minutes. Accordingly, it is desired that values of d and v are determined so that the elapsing time period t is within 15 minutes.

Further, in exemplary embodiments of the present invention, an applying process of applying a material such as a sealant or a conducting material to a surface will be represented with “apply a material to a surface.” An applying process of a spacer to a surface will be represented with “spray a spacer on a surface.” However, an applying process of such materials of the present invention is not limited to a process represented by an only term of “apply” or “spray.” An applying process of the present invention, that is a process for applying a material or spraying a spacer, can be represented by various terms. For example, an applying process may be represented by a phrase of “spread a material on a surface”, “paint a material on a surface” or “put a material on a surface.” Also, an applying process may be represented by a phrase of “coat a surface with a spacer”, “cover the surface with a material”, “paint a surface with a material” or “spread a surface with a material.” And an adhering process of a spacer will be represented with “adhere a spacer.” However, a spacer adhering process of the present invention is not limited to a process represented by an only term of “adhere.” A spacer adhering process of the present invention, that is a process for adhering a spacer, can be represented by various terms. For example, a spacer adhering process may be represented by a phrase of “stick a spacer”, “cure a spacer” or “harden a spacer.”

As mentioned above, because spreadability is improved, a coating failure can be prevented. Additionally, coating amount of a material can be reduced and also an increase in design margin and a decrease in material usage can be achieved.

In a spacer spraying step, a spacer adhering failure caused by contamination on a substrate surface can be improved and cell gap uniformity can be improved.

In a spacer adhering step, an abnormal orientation suddenly generated in an area around a spacer that is caused by contaminant can be reduced.

### 2. Second Exemplary Embodiment

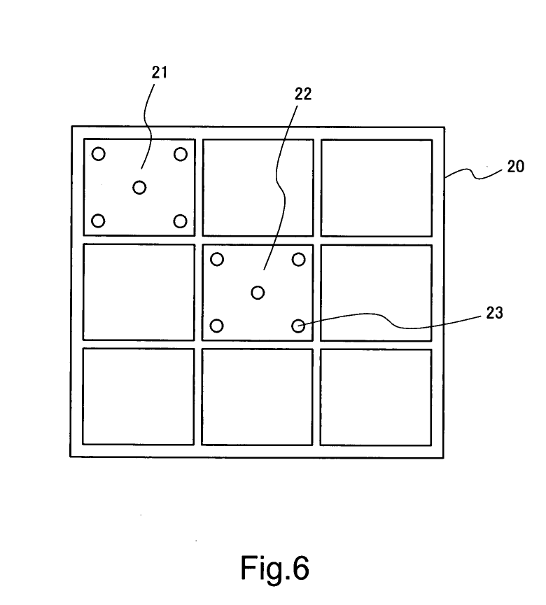

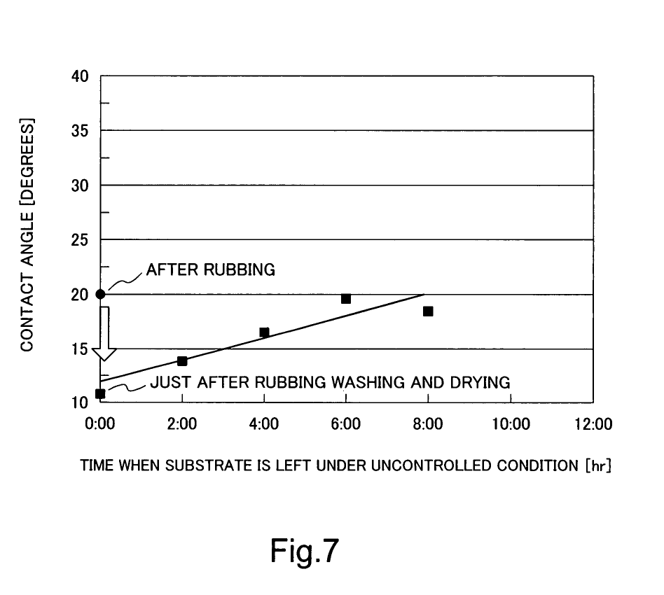

Next, a method and apparatus for manufacturing an LCD panel of the second exemplary embodiment of the present invention will be described with reference to FIG. 6 and FIG. 7. FIG. 6 is a plan view showing a measurement method of a contact angle. FIG. 7 shows a relation between a contact angle and an elapsed time period after rubbing. Further, in this exemplary embodiment, UV cleaning is performed in a sealant applying step or an Ag paste applying step.

In a sealant applying step which is a next step of a rubbing washing & drying step, UV cleaning is performed on a surface of a TFT substrate to which a sealant is applied just before applying a sealant. At this time, a xenon excimer lamp is used for UV cleaning. A contact angle of the TFT substrate is 20 to 30 degrees (sample number n=3) before performing UV cleaning. When UV radiation is performed under conditions in which an accumulated amount of UV light is around 50 mJ/cm² and moving speed of a substrate is around 4000 mm/min, a contact angle of 5 to 7 degrees is obtained. As shown in FIG. 6, a contact angle is quickly measured after dropping pure water 23 to an outside panel 21 and a central panel 22 of a substrate in a glass substrate 20 at five points for each panel. This method of measuring the contact angle is called “sessile drop method.” It is confirmed that spreadability of a sealant such as a linearity of a sealant and stability at a corner part is remarkably improved by applying a sealant to the TFT substrate being cleared. Additionally, an evaluation on a sealant applying is performed to a CF substrate after performing similar UV cleaning to the CF substrate. As a result, a good result is obtained as the same as in the case of the TFT substrate.

Next, in an Ag paste applying step, UV cleaning is performed to a TFT substrate under the same UV cleaning condition as that of the sealant applying step. An Ag paste is applied just after the UV cleaning. As a result, spreadability of the Ag paste such as uniformity of a coated amount of the Ag paste and stability of a coated shape is improved with respect to an Ag applying as the same as in the case of a sealant applying. An evaluation on conductivity of an Ag wiring after a panel assembly shows that conducting resistance value is equal to or less than 1Ω and a good connection is achieved. UV cleaning is also performed to a CF substrate as the same as in the case of the TFT substrate. As a result, a good result is obtained similarly.

Further, in the sealant applying step and the Ag paste applying step, some consideration is required when performing UV cleaning just before a coating. That is, when a UV hardening sealant or a hybrid (i.e. UV hardening+heat hardening) sealant is used, it is desirable that the Ag paste applying step and the sealant applying step are performed in this order in order to prevent a sealant from hardening. However, it is not necessary to follow this order when a material applicator equipped with a coating head with built-in UV lamp that employs a method in which UV cleaning is performed to only an area to which a sealant or an Ag paste is applied is used.

FIG. 7 shows a relation between a contact angle and a time when a substrate is left under uncontrolled condition with respect to a CF substrate after performing rubbing washing & drying. A contact angle of a substrate is 20 degrees at the time when a rubbing process has been completed (black plot in the graph). It can be judged that the contact angle of 20 degrees is large. However, a contact angle can be reduced by about 11 degrees by performing rubbing washing & drying. When a time period under which a substrate is left under uncontrolled condition (i.e., waiting time until the sealant applying or the Ag paste applying is performed from a completion of the rubbing washing & drying) becomes longer, a contact angle becomes larger. In other words, when contamination on a substrate surface gradually spreads and the waiting time t exceeds 2 hours, a contact angle will be 14 degrees. The contamination on the substrate surface at that time largely influences spreadability etc. The contamination spreads and causes deterioration in spreadability of a material due to of delay of processing a substrate which frequently occurs in a line for a mass production. When some troubles suddenly occur in a production line and processes are delayed for a long time, the contamination causes a fatal coating failure.

Accordingly, it is important to provide a UV cleaning processor at a front position of each material applicator so as to perform UV cleaning and material applying continuously in a sealant applying step and an Ag paste applying step. By providing such UV cleaning processor, a material can be applied at any time on a highly clean substrate surface. Thereby, a coating failure can be reduced.

### 3. Third Exemplary Embodiment

Next, a method for manufacturing an LCD panel of the third exemplary embodiment of the present invention will be described. Further, the embodiment is another example in which UV cleaning is performed in a sealant applying step or an Ag paste applying step.

A sealant applying step of the third exemplary embodiment that is a next step of a rubbing washing & drying step is the same as that of the first exemplary embodiment except that gold (Au) balls are included in a sealant. That is, by using a sealant including Au balls, an evaluation on a coating of the sealant is performed to a TFT substrate and a CF substrate as the same as that of the first exemplary embodiment. Further, Au balls are conductive member for electrically connecting electrodes of the TFT substrate and the CF substrate.

As a result, it is confirmed that spreadability of the sealant such as linearity of a sealant and stability at a corner part is remarkably improved. From a result of an evaluation on a conductivity of Au balls that is performed after a panel assembly, it is confirmed that a conductive resistance value is equal to or less than 0.3Ω which shows better connection.

### 4. Forth Exemplary Embodiment

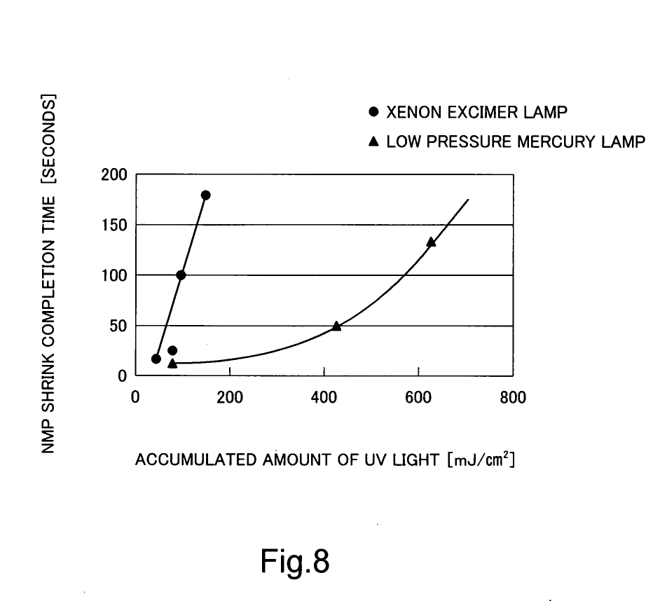

Next, a method for manufacturing an LCD panel of the fourth exemplary embodiment of the present invention will be described with reference to FIG. 8. FIG. 8 shows a relation between an accumulated amount of UV light and NMP (N-methylpyrrolidone) shrink completion time for each type of UV lamps used for UV cleaning. N-methylpyrrolidone is a name of an organic solvent. Further, this embodiment is another example in which UV cleaning is performed in a sealant applying step or an Ag paste applying step.

An evaluation on a coating of a sealant and an Ag paste is performed for the fourth exemplary embodiment. A method for manufacturing an LCD panel of the fourth exemplary embodiment is the same as that of the first exemplary embodiment except that a low pressure mercury lamp is used in UV cleaning. By performing a process at a setting condition in which an accumulated amount of UV light is around 340 mJ/cm² and a moving speed of a substrate is around 4000 mm/min with respect to a low pressure mercury lamp, a contact angle of a TFT substrate and a CF substrate can be reduced to 10 degrees. As a result, it is confirmed that spreadability of a sealant and spreadability of an Ag paste are improved.

FIG. 8 shows an effect of substrate cleaning, that is a confirmed result, for various types of UV lamps. A vertical axis represents a NMP shrink completion time (second) and a horizontal axis represents an accumulated amount of UV light (mJ/cm²). NMP shrink completion time means time until movement of NMP (slow shrinkage of NMP) is completed after smearing a waste which soaks up NMP once on a substrate after completion of UV radiation. When the NMP shrink completion time becomes longer, it means that a surface of a substrate becomes clearer. As shown in FIG. 8, a xenon excimer lamp has an ability to clean a substrate that is equal to or larger than six times that of a low pressure mercury lamp. Accordingly, cleaning on a surface of a substrate can be effectively performed by using a xenon excimer lamp in comparison with a low pressure mercury lamp with respect to a UV lamp.

### 5. Fifth Exemplary Embodiment

Next, a method for manufacturing an LCD panel of the fifth exemplary embodiment of the present invention will be described. Further, the embodiment is an example in which UV cleaning is performed in a spacer spraying step.

In the fifth embodiment, in a spacer spraying step which is a next step of a rubbing washing & drying step, UV cleaning is performed to a surface of a CF substrate where a spacer is sprayed just before spraying a spacer. At the step, a xenon excimer lamp is used for UV cleaning. A contact angle of the CF substrate before performing the UV cleaning is 20 to 30 degrees (sample number n=3). After performing UV cleaning in a condition that an accumulated amount of UV light is around 50 mJ/cm² and a moving speed of the substrate is around 4000 mm/min, a contact angle of 5 to 7 degrees is obtained. A spacer is sprayed on a clean surface of the CF substrate and then the spacer is adhered by a heat treatment. After that, a vibration test is performed after assembling a CF substrate into a panel.

As a result, it is confirmed that a spacer is sufficiently adhered even if the spacer is adhered in a manufacturing lot in which the spacer adhesion strength is slightly weaker than other lots. Also, UV cleaning is similarly performed to a TFT substrate and a vibration test is performed to the panel. As a result, a good result is obtained as the same as in case of the CF substrate.

### 6. Sixth Exemplary Embodiment

Next, a method for manufacturing an LCD panel of the sixth exemplary embodiment of the present invention will be described. Further, this embodiment is an example in which UV cleaning is performed in a spacer adhering step.

In the sixth exemplary embodiment, a spacer is sprayed on a CF substrate in a spacer spraying step. In a spacer adhering step which is a next step thereof, UV cleaning is performed on a surface of the CF substrate just before adhering a spacer. At the step, a xenon excimer lamp is used for UV cleaning. A contact angle of the CF substrate before UV cleaning is 20 to 30 degrees (sample number n=4). After performing UV cleaning in a condition that an accumulated amount of UV light is around 50 mJ/cm² and a moving speed of the substrate is around 4000 mm/min, a contact angle of 5 to 7 degrees is obtained. Thus, a heat treatment is performed to a clean surface of the CF substrate, a spacer is adhered and then the CF substrate is assembled into a panel. After that an indication test is performed. As a result, it is confirmed that an abnormal orientation around a spacer does not exist. UV cleaning is also performed to a TFT substrate as the same as in case of the CF substrate and an indication test is performed. As a result, a good result is obtained as the same as in case of the CF substrate.

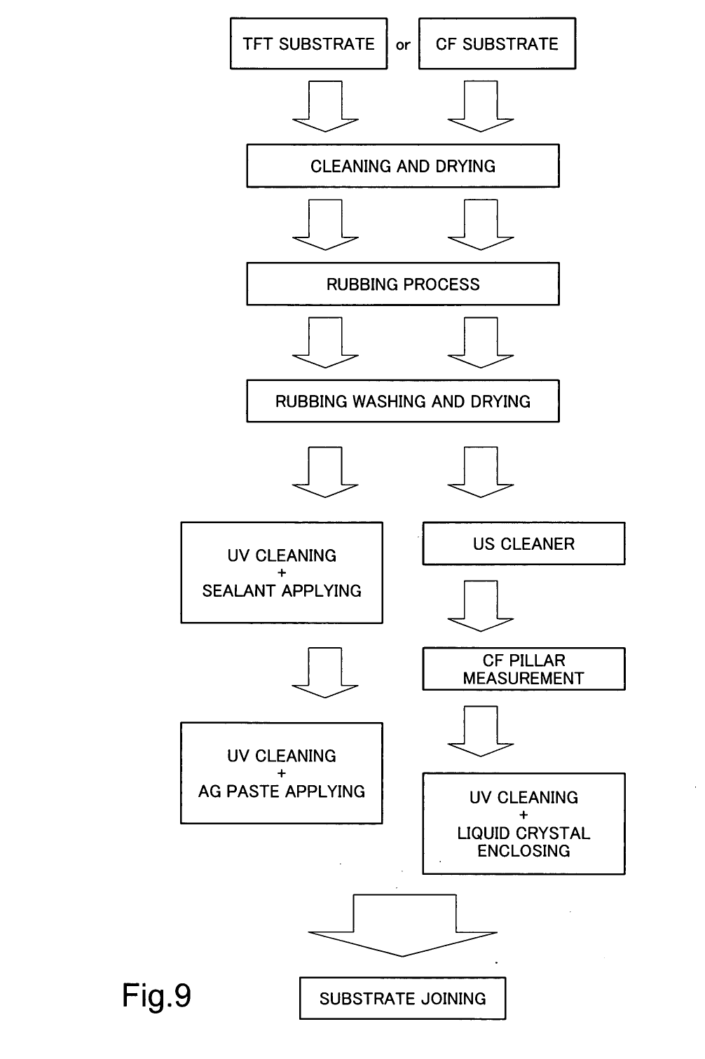

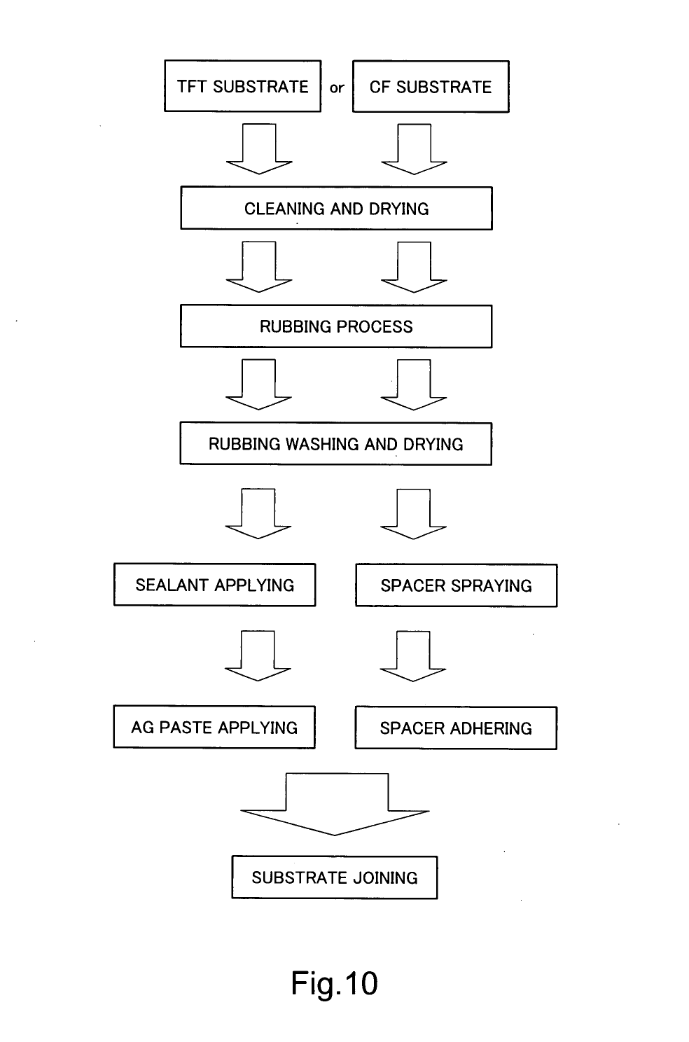

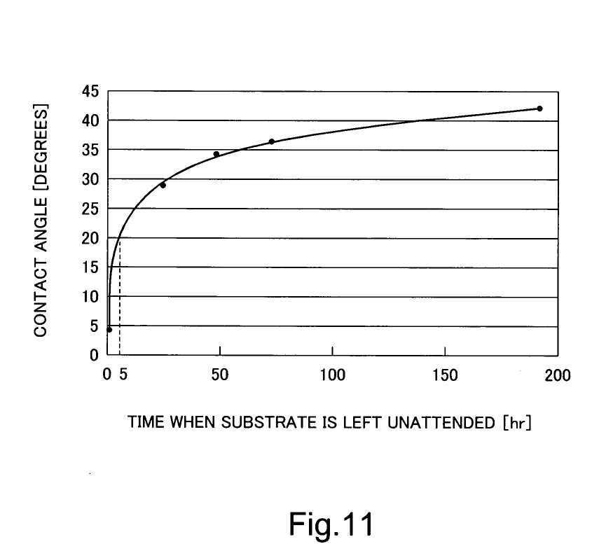

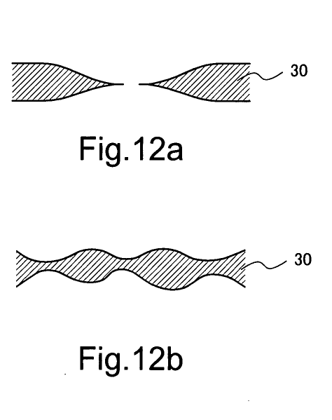

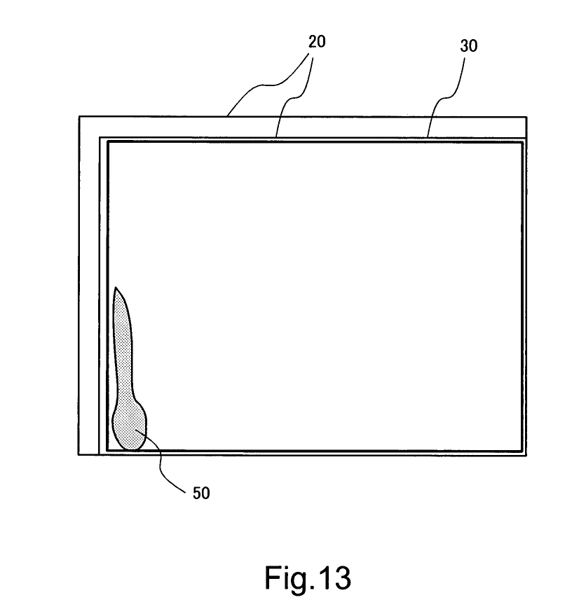

Further, in the fifth and sixth embodiment, UV cleaning is performed just before a spacer spraying step and just before a spacer adhering step, respectively. For example, when a CF substrate having pillars are used, a spacer spraying step and a spacer adhering step are not performed. That is, as shown in FIG. 9, a CF substrate is treated by performing for example, an ultrasonic (US) cleaner step and a CF pillar measurement step instead of the spacer spraying step and the spacer adhering step. In this case, after a completion of the CF pillar measurement, UV cleaning is performed just before arranging liquid crystal with a liquid crystal dropping or a liquid crystal injection (in this case, aligned with a TFT substrate) that is performed in a next step. By using the above method, because liquid crystal can be filled while keeping a surface of a CF substrate clean, a stain or a spot caused by a flow of liquid crystal can be suppressed.

Further, the present invention has features in a process to a substrate of an LCD panel. A structure of an LCD or a structure of each substrate is not limited to the above mentioned embodiments. For example, an IPS (In-Plane Switching) system in which liquid crystal is driven by an electric field approximately parallel to a substrate surface or a TN (Twisted Nematic) system in which a liquid crystal is driven by an electric field crossing at approximately right angles to a substrate surface can be used for a system of an LCD. A transparent type lighting system which uses a backlight source provided at a rear side for an illumination, a reflection type lighting system which uses a surrounding light or a semi-transparent type lighting system which has both functions can be used for a lighting system of an LCD. A bottom gate type (i.e. inverted staggered type) TFT in which a gate electrode is arranged at a lower layer side to a semiconductor layer or a top gate type (i.e. staggered type) TFT in which a gate electrode is arranged at an upper layer side to a semiconductor layer can be used for a TFT of a TFT substrate.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

Further, it is noted that the inventor's intent is to retain all equivalents of the claimed invention even if the claims are amended during prosecution.

This application is based on Japanese Patent Application No. JP 2006-182947 filed on Jul. 3, 2006, and including a specification, claims, drawings and summary. The disclosure of the above Japanese Patent Application is incorporated herein by reference in its entirety.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

Further, it is the inventor's intention to retain all equivalents of the claimed invention even if the claims are amended during prosecution.

What is claimed is:

1. A method for manufacturing a liquid crystal display panel, comprising:
irradiating a position on a substrate used for the liquid crystal display panel with ultraviolet rays; and
performing a process to the position before predetermined time elapses.

2. The method for manufacturing a liquid crystal display panel according to claim 1, wherein
performing the process to the position comprises applying a material to the position.

3. The method for manufacturing a liquid crystal display panel according to claim 2, wherein
the material includes at least one of a sealant, a conductive material and a spacer.

4. The method for manufacturing a liquid crystal display panel according to claim 1, wherein
performing the process to the position comprises adhering a spacer on the position.

5. The method for manufacturing a liquid crystal display panel according to claim 1, wherein
irradiating comprises moving the position in a predetermined direction while irradiating the position with the ultraviolet rays, and
performing comprises starting the process to the position before the predetermined time elapses.

6. The method for manufacturing a liquid crystal display panel according to claim 5, wherein
the process is applying a material.

7. The method for manufacturing a liquid crystal display panel according to claim 6, wherein
the material includes at least one of a sealant, a conductive material and a spacer.

8. The method for manufacturing a liquid crystal display panel according to claim 1, wherein
irradiating comprises moving the position in a predetermined direction while irradiating the position with the ultraviolet rays, and
performing comprises starting the process comprises adhering a spacer to the position.

9. The method for manufacturing a liquid crystal display panel according to claim 1, wherein
the predetermined time is a time when a contact angle on the substrate measured with pure water becomes equal to or less than about 10 degrees.

10. The method for manufacturing a liquid crystal display panel according to claim 1, wherein
the predetermined time is about 15 minutes.

11. The method for manufacturing a liquid crystal display panel according to claim 1, wherein
the predetermined time is within about 15 minutes.

12. The method for manufacturing a liquid crystal display panel according to claim 1, wherein
irradiating comprises irradiating only an area on the substrate to which the process is performed.

13. The method for manufacturing a liquid crystal display panel according to claim 3, wherein
the predetermined time is a time when a contact angle on the substrate measured with pure water becomes equal to or less than about 10 degrees at a starting time of applying the material.

14. A liquid crystal display panel manufacturing apparatus for manufacturing a liquid crystal display panel, comprising:
a process unit including a ultraviolet cleaning unit which irradiates a predetermined position on a substrate with ultraviolet rays and a processing head which performs a predetermined process to the predetermined position on the substrate, the processing head being located at a predetermined distance from the ultraviolet cleaning unit; and
a mobile unit which moves at least one of the process unit and the substrate so as to shift the processing head to the predetermined position before a predetermined time elapses.

15. The liquid crystal display panel manufacturing apparatus for manufacturing a liquid crystal display panel according to claim 14, wherein
the processing head applies a material to the predetermined position.

16. The liquid crystal display panel manufacturing apparatus according to claim 15, wherein
the material includes at least one of sealant, a conductive material and a spacer.

17. The liquid crystal display panel manufacturing apparatus for manufacturing a liquid crystal display panel according to claim 14, wherein
the processing head adheres a spacer to the predetermined position.

18. The liquid crystal display panel manufacturing apparatus according to claim 14, wherein
the predetermined time is a time when a contact angle on the substrate measured with pure water becomes equal to or less than about 10 degrees at a starting time of applying the material.

19. The liquid crystal display panel manufacturing apparatus according to claim 14, wherein
the predetermined time is within about 15 minutes.

20. The liquid crystal display panel manufacturing apparatus according to claim 14, wherein
the ultraviolet cleaning unit irradiates only an area on the substrate where the processing head performs the predetermined process with ultraviolet rays.
